(19) United States
(12) Patent Application Publication
(10) Pub. No.: US 2003/0165626 A1
(43) Pub. Date: Sep. 4, 2003

(54) Method for preparing a material intended for the formation or publication of images and said material

(75) Inventors: Olivier Jean Poncelet, Chalon sur Saone (FR); Ilias Iliopoulos, Paris (FR)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/348,318

(22) Filed: Jan. 21, 2003

(30) Foreign Application Priority Data
Feb. 25, 2002 (FR) 0202324

(51) Int. Cl. B05D 3/02

(52) U.S. Cl. 427/385.5

(57) ABSTRACT

The present invention relates to a method for preparing a material, intended for example for the formation or publication of images, said material enabling the drying time to be reduced by facilitating water evaporation and absorption of the compositions applied to said material.

The material according to the invention comprises a support and at least one hydrophilic binder-based layer, and is characterized in that, in at least one of said hydrophilic binder-based layers, said hydrophilic binder comprises heat-sensitive pairs at LCST, said heat-sensitive parts having been selected so that their LCST is lower than the temperature at which the material was dried.

The material according to the invention can be used as photographic material or as receiving material for aqueous ink compositions applied by the ink jet printing technique.

### FIELD OF THE INVENTION

The present invention relates to a method for preparing a material comprising a support and at least one layer comprising a hydrophilic binder. Said material can be, for example, a material intended for the formation or publication of images, to receive water-based ink compositions by the inkjet printing technique or a photographic material.

### BACKGROUND OF THE INVENTION

Conventionally, materials intended to receive water-based inks by the inkjet printing technique are obtained by coating different layers on a support. It is possible to coat on a support, for example, a primary attachment layer, an absorbent layer, an ink fixing layer and a protective layer or surface layer to provide the gloss of the material. The absorbent layer absorbs the liquid part of the water-based ink composition after creation of the image. Elimination of the liquid reduces the risk of ink migration to the surface. The ink fixing layer prevents any ink loss into the fibers of the paper base to obtain good color saturation while preventing excess ink that would encourage the increase in size of the printing spots and reduce the image quality. The absorbent layer and fixing layer can also constitute a single layer ensuring both functions. The protective layer is designed to ensure protection against fingerprints and the pressure marks of the printer insertion rollers. Some of these layers have a hydrophilic binder base, such as gelatin or polyvinyl alcohol. The various layers, once coated onto the support, must be dried so as to expulse the water coming especially from the layers with a hydrophilic binder base. This drying step has variable duration according to the thickness and number of layers, but it is generally quite long and slows productivity.

Furthermore, it is necessary that the ink applied to the material be rapidly absorbed and dried as fast as possible to obtain good printing quality and enable fast handling of the printed sheet.

Layering technology is also used in the photographic field, where photographic materials are obtained by layering various layers with a hydrophilic binder base onto a support, especially layers of emulsions with silver halides for image formation, but also protection layers, intermediate layers such as an antihalation layer, an antistatic layer, etc. Such arrangements are described in Research Disclosure, publication 38957, page 624, section XI (September 1996). Research Disclosure is a publication of Kenneth Mason Publications, Ltd., Dudley House, 12 North Street, Emsworth, Hampshire PO10 7DQ United Kingdom. Generally, silver halide emulsions and other layering compositions are prepared and then sent to spreading. After the layering of the various layers, the film is dried to expulse the water of the layers with a hydrophilic binder base. Again, this drying step has variable duration according to the thickness and number of layers, but it is generally quite long and can in some cases last several hours. As the manufacturing process of a photographic material is done continuously, a long drying time will cause a reduction of the layering speeds and consequently, a reduction of productivity. This is a major disadvantage in the manufacturing process of a photographic material, for which productivity gains are continuously sought.

EP-A-583 814 discloses polymers containing hydrophilic parts which do not have the LCST property (as defined below) in the useful temperature range and hydrophilic parts which do have the LCST property in the useful temperature range. These polymers are used as thickening agents, especially in the oil industry.

The present invention proposes a method for preparing a material intended for the formation or publication of images, said material enabling the drying time to be reduced by facilitating water evaporation and absorption of the compositions applied to said material, both during its preparation and during its use in the various possible applications.

### SUMMARY OF TIE INVENTION

The present invention relates to a method for preparing a material, intended for example, for the formation or publication of images, comprising a support and at least one hydrophilic binder-based layer, said method comprising the following steps:

(i) cross-linking said hydrophilic binder with at least one heat-sensitive polymer or copolymer, water-soluble at temperatures lower than its lower critical solution temperature LCST and hydrophobic above its LCST, the cross-linking reaction taking place at a temperature lower than the LCST of the heat-sensitive (co)polymer,

(ii) coating on said support at least one hydrophilic binder-based layer comprising heat-sensitive parts obtained according to step (i) and before it forms a chemical gel, and

(iii) drying the material obtained in step (ii), the drying temperature being higher than the LCST of the heat-sensitive parts so that the heat-sensitive parts become hydrophobic during the drying step so as to form heterogeneities in the hydrophilic binder-based layer. These heterogeneities create micropores that enable water to remove more easily during the drying and consequently to reduce the drying times.

The present invention also relates to a material, intended for example for the formation or the publication of images, said material comprising a support and at least one layer comprising a hydrophilic binder, and being characterized in that, in at least one of said layers comprising a hydrophilic binder, said hydrophilic binder includes heat-sensitive parts, said heat-sensitive parts being water-soluble at temperatures below their lower critical solution temperature (LCST) and hydrophobic above their LCST, said heat-sensitive pairs having been selected so that their LCST is lower than the temperature at which the material was dried.

“Heat-sensitive parts” refers to the chains obtained by cross-linking the hydrophilic binder and made of polymers or copolymers themselves having this Lower Critical Solution Temperature or LCST property. Below the LCST, the (co)polymer is soluble in aqueous solutions, and phase separates at temperatures above the LCST. Qualitatively, this phenomenon can be understood as an increased hydrophobicity of the (co)polymer when the temperature increases. That is why it is said in the present description, that the heat-sensitive (co)polymer or heat-sensitive part is hydrophobic above its LCST. Such (co)polymers have an inverse solubility behavior in aqueous media.

In the description that follows, if no specific information is given, the term LCST designates the temperature at which the heat-sensitive part becomes hydrophobic, the polymer or copolymer forming said heat-sensitive part then being cross-linked with the hydrophilic binder. This LCST differs from the LCST of the heat-sensitive polymer or copolymer when the latter is not cross-linked with the hydrophilic binder. In general, the LCST of the heat-sensitive parts cross-linked with the hydrophilic binder is higher than the LCST of the heat-sensitive polymer or copolymer alone.

Preferably, the material according to the present invention comprises a gelatin-based layer comprising as heat-sensitive parts of copolymer N-isopropylacrylamide and acrylic acid chains.

### BRIEF DESCRIPTION OF THE DRAWINGS

FIGS. 1 and 2 represent the evolution of the elastic modulus as a function of the time of a hydrophilic binder comprising the heat-sensitive parts used in the present invention and another binder without heat-sensitive parts for comparison,

FIGS. 3 and 4 represent desiccation curves at 40° C. and 60° C. as a function of the time of the various materials, and

FIG. 5 represents the wetting angle as a function of the time of the various materials.

### DETAILED DESCRIPTION OF THE INVENTION

The material according to the present invention comprises firstly a support. This support is selected according to the desired use. It can be a transparent or opaque thermoplastic film, in particular a film based on polyester (e.g. polyethylene terephthalate), polymethylmetacrylate, cellulose acetate, or polyvinyl chloride, or any other appropriate material. The support used in the invention can also be paper, both sides of which can be covered with a polyethylene layer. Such a support is particularly preferred to constitute a material to receive ink applied by the ink jet printing technique. The side of the support that is used can be coated with a very thin layer of gelatin to ensure the adhesion of the first layer on the support. Such a support is called Resin Coated Paper (RC Paper).

The material according to the invention then comprises at least one layer comprising a hydrophilic binder, which can be gelatin or polyvinyl alcohol. The gelatin is that conventionally used in photography. Such gelatin is described in Research Disclosure September 1994, No 36544, part IIA, whose reference was mentioned above. The gelatin can have undergone various appropriate treatments, but in a way that keeps groupings capable of reacting with the reactive groups of the heat-sensitive polymer during the cross-linking reaction enabling gelatin comprising heat-sensitive parts to be obtained. The gelatin can be obtained from SKW and the polyvinyl alcohol from Nippon Gohsei, or Air Product with the name Airvol® 130.

According to the present invention, in at least one hydrophilic binder-based layer, said hydrophilic binder comprises heat-sensitive parts obtained by cross-linking a heat-sensitive polymer or copolymer with the hydrophilic binder. It is therefore necessary to provide the heat-sensitive (co)polymer with units capable of reacting with the hydrophilic binder for the cross-linking reaction. The cross-linking is carried out according to conventional techniques known to those skilled in the art, especially using a cross-linking agent, such as a water-soluble carbodiimide, e.g. 1-(3-dimethylaminopropyl)-3-ethyl-carbodiimide hydrochloride (EDC). The heat-sensitive (co)polymers useful in the present invention to form the heat-sensitive parts are selected from among the homopolymers and copolymers based on N-isopropyacrylamide, N-vinylcaprolactame, N-vinylisobutyramide, and vinylmethylether. The copolymers comprise units selected from among the group comprising for example acrylic acid and methacrylic acid. The polymers and copolymers useful in the invention, in particular for photographic applications, preferably have a molecular weight of less than 500,000, and preferably less than or equal to 60,000 so as not to reduce too much the gelatin's gelification temperature.

The selection of the nature and proportions of the various components used to prepare the hydrophilic binder-based layer is carried out according to the value of the LCST of the heat-sensitive parts sought. In this way, the nature of the monomers incorporated in the heat-sensitive polymers has an influence on the LCST: the incorporation of hydrophilic monomers leads to an increase of the LCST; conversely, the introduction of hydrophobic monomers leads to a reduction of the LCST. The incorporation of ionic groups increases the solubility of the copolymer in water and thus also the value of its LCST. When a heat-sensitive copolymer comprising acrylic acid units is used, preferably a basic pH is set, the acid groups being then in ionized form, so as to increase the copolymer's water solubility. In this way, the more the number of acrylic acid units in the copolymer is increased, said units being essentially in ionic form, the more the LCST increases.

Preferably for the invention, a coating composition having a concentration of hydrophilic binder between 2% and 15% by weight and a concentration of heat-sensitive parts between 1% and 5% by weight compared with the total weight of said coating composition, the hydrophilic binder/heat-sensitive parts ratio being preferably more than 1.5/1, is used to produce the hydrophilic binder layer comprising heat-sensitive parts. In the present invention, preferably an N-isopropylacrylamide and acrylic acid copolymer is used, said copolymer having a molecular weight of 30,000 g/mol, the proportion of acrylic acid units incorporated being less than or equal to 10% compared with the total amount of monomer units.

The material according to the invention is prepared according to a method comprising the following steps:

(i) cross-linking the hydrophilic binder with at least one heat-sensitive polymer or copolymer, water-soluble at temperatures lower than its lower critical solution temperature LCST and hydrophobic above its LCST, the cross-linking reaction taking place at a temperature lower than the LCST of said heat-sensitive (co)polymer,

(ii) coating on said support at least one hydrophilic binder-based layer comprising heat-sensitive parts obtained according to step (i) and before it forms a chemical gel, and

(iii) drying the material obtained in step (ii), the drying temperature being higher than the LCST of the heat-sensitive parts.

Before the cross-linking step (i), the hydrophilic binder that will have the heat-sensitive parts can be prepared according to the sought application of the material according to the invention. When the material according to the invention is intended for use in the photographic field, it comprises at least one hydrophilic binder-based layer having heat-sensitive parts, said layer constituting an image-forming silver halide emulsion layer. In this case, the hydrophilic binder that will have heat-sensitive parts is preferably gelatin, and can be prepared, in addition to the special aspects of the preparation method according to the invention, according to conventional operations as described in Research Disclosure, publication No 36544, September 1994, page 501, chapter I, II, III to form the appropriate emulsions. The emulsions can contain the conventional additives used, as mentioned in the above-mentioned Research Disclosure, chapter VI, VII, and VIII. The emulsions can still contain other additives, such as agents modifying the mechanical or physical properties of the layers, as described in the above-mentioned Research Disclosure, chapter IX. However, the additives must be compatible with the heat-sensitive parts cross-linked with the hydrophilic binder.

When the material according to the invention is intended for applications involving inkjet printing, it comprises at least one hydrophilic binder-based layer having heat-sensitive parts and intended to receive an aqueous ink composition coated by said ink jet printing technique. In this case the hydrophilic binder having heat-sensitive parts can contain the conventional additives used in ink jet applications, but that must be compatible with said heat-sensitive parts. For example, the hydrophilic binder can contain inorganic particles, like boehmite, mixed with the hydrophilic binder before the cross-linking reaction.

When the hydrophilic binder is ready, it is mixed with the cross-linking agent and the heat-sensitive polymer or copolymer for the cross-linking reaction.

It is essential that the cross-linking reaction temperature be lower than the LCST of the heat-sensitive (co)polymer so that the heat-sensitive polymer or copolymer is in soluble phase in order to prevent an uncontrolled phase separation and that the units capable of reacting with the hydrophilic binder are accessible for the cross-linking reaction.

Once the hydrophilic binder having heat-sensitive parts is prepared, it is coated on an appropriate support. The expression “coated on” does not mean that the hydrophilic binder layer having heat-sensitive parts is in direct contact with the support, but can be more or less distant from said support, according to the function required of said layer. The coating step (ii) is carried out very quickly after the cross-linking step (i) where the mixing of the hydrophilic binder/heat-sensitive (co)polymer is carried out and in all cases before said mixture of hydrophilic binder/heat-sensitive copolymer forms a chemical gel. The sequencing of steps (i) and (ii) is well known to those skilled in the art.

The coating on the support uses conventional coating processes. The various layers, comprising at least one hydrophilic binder-based layer having heat-sensitive parts obtained according to step (i), can be applied for example by coating by blade, knife, curtain, or any other appropriate coating technique. The coated thicknesses are those used conventionally in photographic applications or for ink jet printing.

After the coating, the material according to the invention is dried in a dryer or any other appropriate device enabling the drying temperatures to be adjusted. It is essential that the drying be carried out at a temperature higher than the LCST of the heat-sensitive parts. In this case, the heat-sensitive parts are in hydrophobic phase and cause the formation of heterogeneities. These heterogeneities create micropores that enable the water to remove more easily when drying. Thus the drying times are reduced, which enables coating speeds and productivity to be increased.

The following examples illustrate the present invention without however limiting the scope.

1) Preparation of Heat-Sensitive Copolymers

Two copolymers of N-isopropylacrylamide and acrylic acid, molecular weight near 30,000 g/mol, one having 5% of acrylic acid units, the other having 10% acrylic acid units were prepared. These copolymers were then called PNIPAM-5 and PNIPAM-10.

m₁ g of N-isopropylacrylamide, marketed by Aldrich, and m₂ g acrylic acid marketed by Fluka, and about 90 ml water were introduced into a three-necked flask to obtain an aqueous solution of about 1M in monomers. The flask was put in a water bath at 25° C., in nitrogen atmosphere, and placed under a condenser. The solution was stirred. V₁ ml of 1M NaOH were then added to neutralize the acrylic acid 90%. A final pH of the reaction mixture of about 5.5/6 was obtained. m₃ g of NaCl salt were added to achieve a salt concentration of 0.2 M.

The redox initiators, i.e. m₄ g of (NH4)₂S₂O₈, and m₅ g of Na₂S₂O₅, were dissolved in the remaining water needed to achieve total volume of water 100 ml. This mixture was stirred overnight, than dialyzed for one week against pure water. Then, the solution containing the copolymer was lyophilized.

For comparison, a non-heat-sensitive copolymer of N,N-dimethylacrylamide and acrylic acid including 5% acrylic acid units was prepared. The synthesis was the same as that described above, N-isopropylacrylamide being replaced by N,N-dimethylacrylamide.

The quantities of products used are given in Table I below:

TABLE I

| | NIPAM | | | | | |
|---|---|---|---|---|---|---|
| | or | | | (NH₄)₂S₂O | | |
| | DMAM | AA | NaCl | ₈ | Na₂S₂O₅ | NaOH |
| Copolymer | m₁ g | m₂ g | m₃ g | m₄ g | m₅ g | V₁ ml |
| PNIPAM-5 | 10.8 | 0.36 | 1.169 | 0.288 | 0.19 | 4.5 |
| PNIPAM-10 | 10.2 | 0.721 | 1.169 | 0.288 | 0.19 | 9 |
| PDMAM-5 | 9.41 | 0.36 | 1.169 | 0.288 | 0.19 | 4.5 |

Total volume = 100 ml
NIPAM = N-isopropylacrylamide
DMAM = N,N-dimethylacrylamide
AA = acrylic acid
PNIPAM-5 = copolymer of N-isopropylacrylamide and acrylic acid containing 5% acrylic acid units compared with the total amount of monomer units
PNIPAM-10 = copolymer of N-isopropylacrylamide and acrylic acid containing 10% acrylic acid units compared with the total amount of monomer units
PDMAM-5 = copolymer of N,N-dimethylacrylamide and acrylic acid containing 5% acrylic acid units compared with the total amount of monomer units

In the copolymers obtained, the acrylic acid units were essentially in sodium salt form.

The LCST of the obtained copolymers (1% solution in water) was measured by static light scattering. The average of the scattered intensity as a function of the temperature is measured. These measurements inform on the LCST of the thermo-sensitive copolymers based on NIPAM.

In the case of PNIPAM in aqueous solution, and at temperatures below the LCST, the scattered intensity is relatively weak because the polymer chains are solubilized. At a temperature above the LCST, chains are in form of globules, which are agglomerated, so the scattered intensity increases.

For the measurements, an argon ionized Spectra Physics model 2020 laser was used (λ=514.5 nm). Angles of measurements chosen were 90° and 130°. The samples were placed in the instrument thermostated at 60° C. and the temperature was decreased to 10° C.

Using viscosity measurement, the molecular weight of the copolymers obtained is also measured. The results are given in Table II below.

TABLE II

| | Molecular weight | LCST (1% solution in |
|---|---|---|
| Copolymer | (g) | water) |
| PNIPAM-5 | ≅30 000 | 35° C. |
| PNIPAM-10 | ≅30 000 | 44° C. |
| PDMAM-5 | Not measured | >100° C. |

It can be seen that the LCST of PNIPAM-10 is higher than that of PNIPAM-5, which contains fewer acrylic acid units in ionic form.

2) Cross-Linking Reaction of Hydrophilic Binder/Heat-Sensitive Copolymer

A hydrophilic binder gelatin was used, which having undergone special treatments, contained amine functions but not acid groupings. Such gelatin was supplied by SKW in granular form.

The gelatin grains were put into solution at 40° C. until complete dissolution and then left at 60° C. for 10 minutes. The gelatin solution was kept at 40° C.

Solutions of copolymers PNIPAM-5 and PNIPAM-10 obtained according to paragraph 1 were prepared and said solution was kept at 35° C.

Cross-linking agent 1-(3-dimethylaminopropyl)-3-ethyl-carbodiimide hydrochloride (hereafter called EDC) was used, which reacted with the copolymer acid functions and the gelatin amine functions to form amide links.

Just before mixing, an EDC solution was prepared at ambient temperature.

The gelatin, heat-sensitive copolymer (PNIPAM-5 or PNIPAM-10) obtained according to paragraph 1 and the EDC were mixed vigorously, the quantities being selected so as to obtain a final mixture of 5% gelatin, 1% copolymer compared with the total weight of the mixture and 10 mM EDC. The cross-linking reaction was carried out at a temperature less than the LCSTs of the copolymers.

3) Kinetic of the Formation of a Chemical Gel of the Mixture of Gelatin 5%/PNIPAM-5 1%/10 mM EDC

The kinetic of the formation of a chemical gel of the gelatin 5%/PNIPAM-5 1%! 10 mM EDC mixture obtained was monitored Theologically. The measurements were carried out dynamically using an RFS II (Rheometrics Fluids Spectrometer) manufactured by Rheometrics Scientific, Inc.

The elastic modulus G′ of the mixture at a given temperature was measured. The elastic modulus G′ enables the evolution of the chemical cross-linking process to be monitored in time. The given temperature was arrived at, with low deformation (0.5%) and low frequency (ω=10 rad/s) so as not to distort the mixture irreversibly and change its properties. A pre-shear was carried out at the start to homogenize the mixture (30 s⁻¹ for 100 s). Then the evolution of the elastic modulus G′ was monitored during the formation of the chemical gel as far as the plateau corresponding to the modulus of the gel obtained.

A Couette set up was used, constituted of an internal cylinder (Ø=16.5 mm and h=13 mm) immersed in a cylindrical tank (Ø=17 mm) containing the mixture as prepared above. The mixture was put directly into the Couette tank previously adjusted to the required temperature.

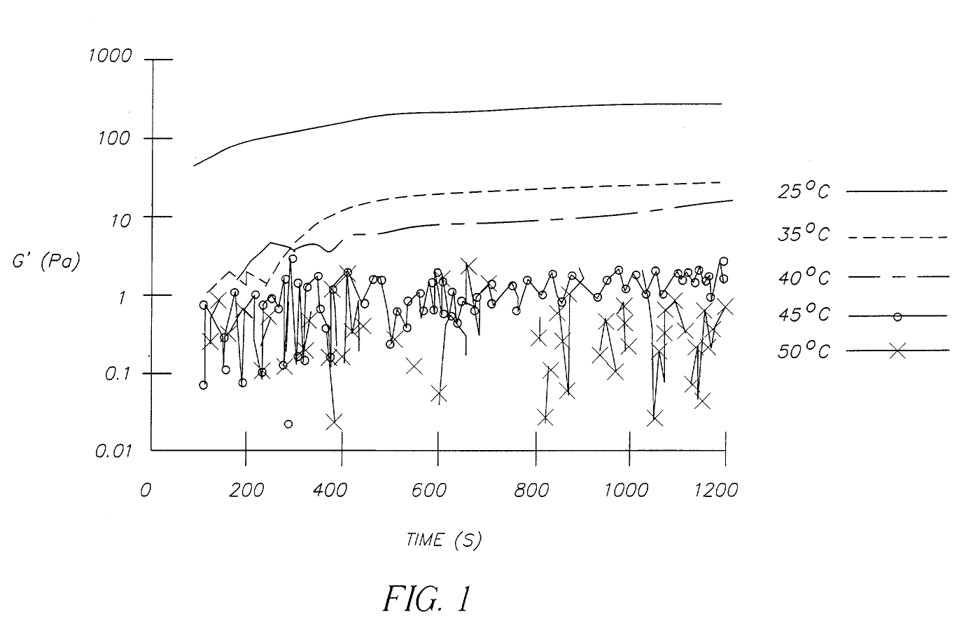

The results are shown in FIG. 1 which represents the evolution of the elastic modulus G′ as a function of time of the gelatin 5% PNIPAM-5 1%/10 mM EDC mixture.

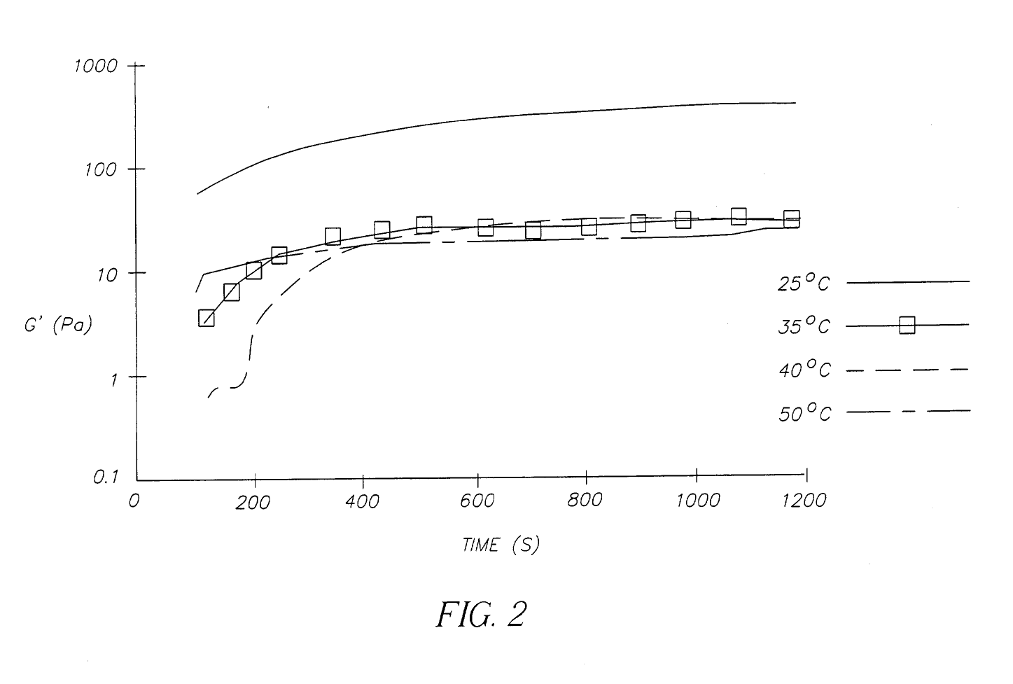

For comparison, the above experiment was repeated but using PDMAM-5, non-heat-sensitive copolymer N,N-dimethylacrylamide (DMAM) and acrylic acid, containing 5% acrylic acid units, as prepared according to paragraph 1. The mixture was made from 5% gelatin, 1% said copolymer PDMAM-5, and 10 mM EDC. The results are shown in FIG. 2 which represents the evolution of the elastic modulus G′ of a gelatin 5% PDMAM-5 1%/10 mM EDC mixture.

FIG. 1 shows that the cross-linking kinetic depends strongly on the temperature when the mixture containing the heat-sensitive copolymer is used. Three types of behavior can be seen:

at 25° C., a double network was formed, both chemically (formation of amide bridges between the gelatin and the copolymer) and physically (conventional gel of the gelatin), the elastic modulus G′ rapidly reached high values (≈300 Pa in 20 minutes)

at 35° C. and 40° C., values near the measured LCST of the PNIPAM-5, only the chemical network was formed and the value of G′ was lower 10-20 Pa)

for temperatures higher than 40° C. and thus far from the measured LCST of the PNIPAM-5, the chemical gel cannot be formed because the PNIPAM-5 chain stays in its compact hydrophobic conformation since it is above the LCST. The sample stays liquid and the apparatus is not able to measure G′ usefully.

These results show that to produce the hydrophilic binder having heat-sensitive parts, it has to be at a cross-linking temperature lower than the LCST of the copolymer. This also shows that by being sufficiently above the LCST, e.g. 50° C., chemical gel formation does not occur.

FIG. 2 shows that at 25° C., the kinetic is still governed by the gelatin. Then the chemical gel formation is all the more rapid as the temperature is increased. This can be explained by the fact that the reactivity of the cross-linking agent increases with the temperature and as the polymer is not sensitive at the temperature, the chains always remain accessible for the cross-linking reaction.

4) Preparation of a Material According to the Invention

The material according to the invention prepared according to the example below is particularly intended for applications for ink jet printing.

Gelatin having heat-sensitive parts of copolymer N-isopropylacrylamide and acrylic acid prepared according to paragraph 2 is applied to a polyester support film of the Resin Coated Paper type. For this, the support film is applied to a bench thermostatically regulated to 20° C. and is attached to the bench by suction using a vacuum extractor. The mixture obtained according to paragraph 2 is coated on the support film using a doctor blade 0.5 mm thick and then it is left to dry for 10 minutes to enable the gelatin to set. This coating step is carried out in the minute following the preparation of the mixture before said mixture forms a chemical gel. Then 6×7 cm pieces were cut and stapled to an aluminum cup, the whole being dried at 60° C. in a dessicator (Sartorius MA100 manufactured by Sartorius AG). This drying temperature is well above the LCST of the heat-sensitive parts prepared according to paragraph 2. Thus the materials according to the invention were obtained, one being obtained from the gelatin 5%/PNIPAM-5 1%/10 mM EDC mixture, the other being obtained from the gelatin 5%/PNIPAM-10 1%/10 mM EDC mixture.

For comparison, also made according to the same process was a material comprising a support film of the Resin Coated Paper type and a layer obtained from the gelatin 5%/PDMAM-5 1%/10 mM EDC mixture to form non-heat-sensitive copolymer chains. The material was also dried at 60° C.

Photographs of the vertical cross-sections of the various dry films obtained were taken using optical microscopy. Films containing gelatin having non-heat-sensitive chains of copolymer PDMAM-5 were perfectly clear and showed no heterogeneity.

However, films containing gelatin having heat-sensitive chains of copolymer N-isopropylacrylamide and acrylic acid and dried at 60° C. (temperature higher than the LCST of the heat-sensitive parts) showed clear heterogeneities. It was also observed that the film comprising chains of copolymer PNIPAM-5 had more heterogeneities than the film comprising the chains of copolymer PNIPAM-10. Once dried, the films keep well the “memory” of the micro-heterogeneities that they had in the wet state when the drying temperature was higher than the LCST.

For comparison, the drying was carried out of the same compositions at 40° C. None of the films obtained, including films comprising heat-sensitive chains of copolymer N-isopropylacrylamide and acrylic acid had visible heterogeneity. At this temperature, only the film containing the copolymer PNIPAM-5 should have small heterogeneities. Nevertheless, they should not be significant because it was only a few degrees above the LCST, and they were thus not visible.

This clearly demonstrates that if the drying temperature is not sufficiently higher than the LCST of the heat-sensitive parts, these do not go into compact hydrophobic conformation and the phase separation does not take place.

5) Dessication Measurements of the Materials According to the Invention

The various materials prepared according to paragraph 4 above were dried at 40° C. and at 60° C. in a dessicator (Sartorius MA100 manufactured by Sartorius AG) which is a heating balance that measures the weight loss at a set temperature as a function of time.

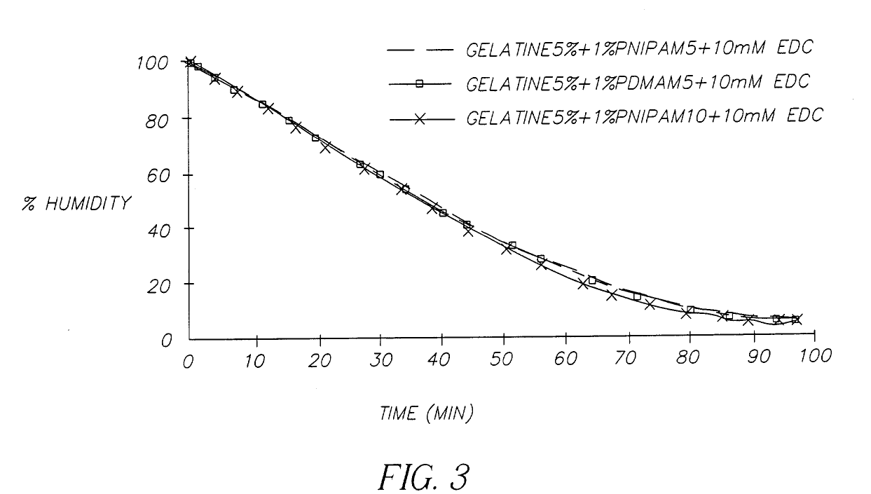

FIG. 3 represents the variation of the humidity percentage as a function of time for drying at 40° C., for films obtained from a gelatin 5%/PNIPAM-5 1%/10 mM EDC mixture, a gelatin 5%/PNIPAM-10 1%/10 mM EDC mixture (heat-sensitive copolymers), and a gelatin 5%/PDMAM-5 1%/10 mM EDC mixture (non-heat-sensitive copolymer).

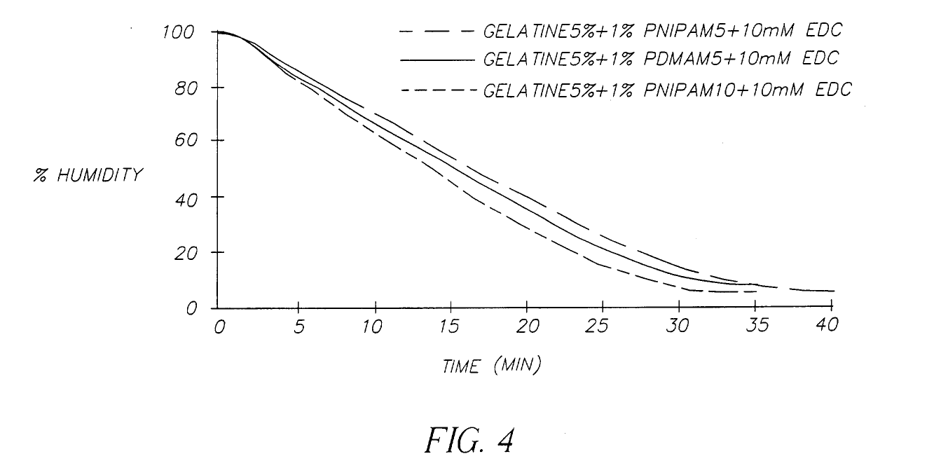

FIG. 4 represents the variation of humidity percentage as a function of time for drying at 60° C., for the same films.

The results show that at 40° C., a temperature near the LCST of the heat-sensitive parts, the drying curves are almost identical, independently of the nature of the copolymer used.

On the contrary, the results show that the films containing heat-sensitive parts (PNIPAM-5 and PNIPAM-10) dried at 60° C., i.e. at a temperature higher than their LCST, dry faster than the film containing the non-heat-sensitive PDMAM-5. At this temperature, the first two copolymers have heterogeneities, enabling water to clear more easily. The drying time is reduced by about 15% (calculated for 20% residual humidity) for the material containing the PNIPAM-5, compared with the non-heat-sensitive material containing the PDMAM-5.

It was also observed that the material comprising the PNIPAM-10 dried slower than that containing the PNIPAM-5. This confirmed that the PNIPAM-10 at 60° C. forms smaller heterogeneities.

6) Wetting of Materials According to the Invention

The various films dried at 40° C. and 60° C. obtained after the measurements according to paragraph 4 above were used. A drop of water was placed on said films and the evolution of the water drop was measured by measuring the variation of the contact angle using a Tracker tensiometer manufactured by I.T.Concept. The apparatus comprised a thermostatically regulated support for holding the film and an adjustable height syringe for placing the water drop. The apparatus measured the contact angle of the drop over time. The measurements were carried out at 25° C.

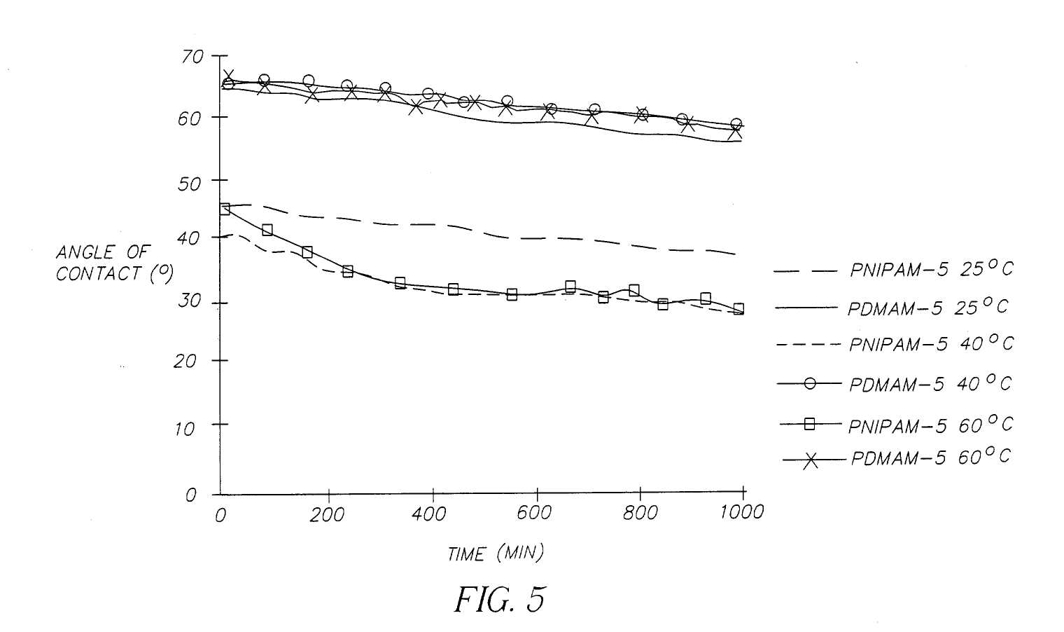

FIG. 5 represents the variation of the contact angle as a function of time for the films obtained from a gelatin 5%/PNIPAM-5 of a gelatin 5%/PDMAM-5 1%/10 mM EDC mixture dried at 25° C., 40° C. and 60° C.

The results show that whatever the drying temperature, the films containing the PNIPAM had a contact angle clearly less than those containing the PDMAM. The drying temperature had no influence on the evolution of the contact angle for PDMAM-5-based materials. This is normal as the system is not heat-sensitive.

However, the behavior of the material containing the PNIPAM-5 strongly depended on the drying temperature, as has already been shown. The wetting angle changed much faster (less pronounced slopes) for films having heterogeneities (films dried at 40° C. and 60° C.).

Thus, the creation of heterogeneities in the material according to the invention enables its properties of drying and water absorption to be increased.

What is claimed is:

1. A method for preparing a material comprising a support and at least one hydrophilic binder-based layer, said method comprising the following steps:
(i) cross-linking said hydrophilic binder with at least one heat-sensitive polymer or copolymer, water-soluble at temperatures lower than its lower critical solution temperature LCST and hydrophobic above its LCST, the cross-linking reaction taking place at a temperature lower than the LCST of the heat-sensitive (co)polymer,
(ii) coating on said support at least one hydrophilic binder-based layer comprising heat-sensitive parts obtained according to step (i) and before it forms a chemical gel, and
(iii) drying the material obtained in step (ii), the drying temperature being higher than the LCST of the heat-sensitive parts.

2. The method according to claim 1, wherein the hydrophilic binder is selected from among gelatin or polyvinyl alcohol.

3. The method according to claim 1, wherein the heat-sensitive polymer or copolymer comprise chains selected from among the homopolymers and copolymers based on N-isopropylacrylamide, N-vinylcaprolactame, N-vinylisobutyramide, and vinylmethylether, said chains comprising units able to cross-link with the hydrophilic binder.

4. The method according to claim 3, wherein said units able to cross-link with the hydrophilic binder are selected from among the group comprising acrylic acid and methacrylic acid.

5. The method according to claim 1, wherein the hydrophilic binder-based layer having heat-sensitive parts is produced from a coating composition having a concentration of hydrophilic binder between 2% and 15% by weight and a concentration of heat-sensitive polymer or copolymer between 1% and 5% by weight compared with the total weight of said coating composition.

6. The method of the claim 1, wherein the heat-sensitive parts are chains of copolymer N-isopropylacrylamide and acrylic acid, said copolymer having a molecular weight 500,000, and the proportion of acrylic acid units incorporated being less than or equal to 10% compared with the total amount of monomer units.

7. The method according to claim 1, wherein the cross-linking reaction according to step (i) is carried out in the presence of carbodiimide.

8. The method according to claim 1, wherein at least one of said hydrophilic binder-based layers having heat-sensitive parts is a receiving layer for aqueous ink compositions applied by the ink jet printing technique.

9. The method according to claim 1, wherein at least one of said hydrophilic binder-based layers having heat-sensitive parts is an image-forming silver halide emulsion layer.

10. A material comprising a support and at least one hydrophilic binder-based layer, characterized in that, in at least one of said hydrophilic binder-based layers, said hydrophilic binder includes heat-sensitive parts, said heat-sensitive parts being water-soluble at temperatures below their lower critical solution temperature (LCST) and hydrophobic above their LCST, said heat-sensitive parts having been selected so that their LCST is less than the temperature at which the material was dried.

11. The material according to claim 10, wherein the hydrophilic binder is gelatin or polyvinyl alcohol.

12. The material according to claim 10, wherein the heat-sensitive parts are chains selected from among the homopolymers and copolymers based on N-isopropylacrylamide, N-vinylcaprolactame, N-vinylisobutyramide, and vinylmethylether, said chains comprising units able to cross-link with the hydrophilic binder.

13. The material according to claim 12, wherein said units able to cross-link with the hydrophilic binder are selected from among the group comprising acrylic acid and methacrylic acid.

14. The material according to claim 10, wherein at least one of said hydrophilic binder-based layers having heat-sensitive parts is a receiving layer for aqueous ink compositions applied by the ink jet printing technique.

15. The material according to claim 14, wherein said hydrophilic binder-based layer having heat-sensitive parts comprises inorganic particles.

16. The material according to claim 10, wherein at least one of said hydrophilic binder-based layers having heat-sensitive parts is an image-forming silver halide emulsion layer.
